(19) United States
(12) Patent Application Publication
(10) Pub. No.: US 2013/0096995 A1
(43) Pub. Date: Apr. 18, 2013

(54) ELECTRIC VEHICLE CHARGING SERVICES

(71) Applicant: Martin E. Rosalik, JR., Oakland, MI (US)

(72) Inventor: Martin E. Rosalik, JR., Oakland, MI (US)

(73) Assignee: GM Global Technology Operations LLC, Detroit, MI (US)

(21) Appl. No.: 13/273,309

(22) Filed: Oct. 14, 2011

(51) Int. Cl. G06Q 30/02

(52) U.S. Cl. 705/14.1

(57) ABSTRACT

Electric vehicle charging services include receiving data relating to a vehicle charge operation of a vehicle and a user identification of the user initiating the vehicle charge operation. Upon determining the user has registered for the electric vehicle charging services, the electric vehicle charging services include identifying a location of the vehicle, determining a utility service provider that services the location, the utility service provider offering discounted electricity rates to operators of electric vehicles, and transmitting charge data and the user identification received from the vehicle to the utility service provider.

### FIELD OF THE INVENTION

The subject invention relates to electric vehicles, and more particularly, to electric vehicle charging services.

### BACKGROUND

In order to offer discounted rates for electrical energy used to charge electric or hybrid vehicles, typically a utility service provider installs a specialized electric meter at a customer's premises. This specialized electric meter may be provided at a cost to the customer.

In some cases, the customer may not be permitted to have this meter installed, for example, where the customer resides in an apartment building, condominium, or housing development with restrictions. Further, for customers that have multiple residences, vacation homes, or boat slips, a specialized meter and installation services would be required for each of the sites.

Accordingly, it is desirable to provide a way for utility service providers to offer discounted off-peak energy rates to customers owning or operating electric vehicles without the need for any specialized hardware and associated costs.

### SUMMARY OF THE INVENTION

In one exemplary embodiment of the invention, a system for implementing electric vehicle charging services is provided. The system includes a host system computer, and logic executable by the host system computer. The logic is configured to implement a method. The method includes receiving data relating to a vehicle charge operation of a vehicle and a user identification of the user initiating the vehicle charge operation. Upon determining the user has registered for the electric vehicle charging services, the method includes identifying a location of the vehicle, determining a utility service provider that services the location, the utility service provider offering discounted electricity rates to operators of electric vehicles, and transmitting charge data, time of the vehicle charge operation, and the user identification received from the vehicle to the utility service provider. The charge data and the time of the vehicle charge operation is determined a rate chargeable to the user.

In another exemplary embodiment of the invention, a method for implementing electric vehicle charging services is provided. The method includes receiving data relating to a vehicle charge operation of a vehicle and a user identification of the user initiating the vehicle charge operation. Upon determining the user has registered for the electric vehicle charging services, the method includes identifying a location of the vehicle, determining a utility service provider that services the location, the utility service provider offering discounted electricity rates to operators of electric vehicles, and transmitting charge data, time of the vehicle charge operation, and the user identification received from the vehicle to the utility service provider. The charge data and the time of the vehicle charge operation is determined a rate chargeable to the user.

In yet another exemplary embodiment of the invention a computer program product for implementing electric vehicle charging services is provided. The computer program product includes a computer-readable storage medium having instructions embodied thereon, which when executed by a computer, cause the computer to implement a method. The method includes receiving data relating to a vehicle charge operation of a vehicle and a user identification of the user initiating the vehicle charge operation. Upon determining the user has registered for the electric vehicle charging services, the method includes identifying a location of the vehicle, determining a utility service provider that services the location, the utility service provider offering discounted electricity rates to operators of electric vehicles, and transmitting charge data, time of the vehicle charge operation, and the user identification received from the vehicle to the utility service provider. The charge data and the time of the vehicle charge operation is determined a rate chargeable to the user.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a system upon which electric vehicle charging services may be implemented in accordance with an exemplary embodiment of the invention; and

FIG. 2 is a flow diagram describing a process for implementing electric vehicle charging services in accordance with an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment of the invention, electric vehicle charging services are provided. The electric vehicle charging services allow owners and operators of electric or hybrid vehicles to receive discounted electric rates for electrical energy consumed by their vehicles from utility service providers who agree to participate in these services. Once a vehicle owner or operator registers for the electric vehicle charging services and initiates a charge operation, the vehicle components capture the amount of energy consumed in the charge operation and transmit this information, along with user identification and current location information to the electric vehicle charging services provider via a telematics system, and the electric vehicle charging services provider, in turn, provides this information to the corresponding utility service provider. The utility service provider provides the discounted rate and bills the user using the information received from the electric vehicle charging services provider. By transmitting the user identification information, location information, and charge data via a telematics system and network, no additional hardware or devices are needed, such as a smart meter or other specialized instrumentation.

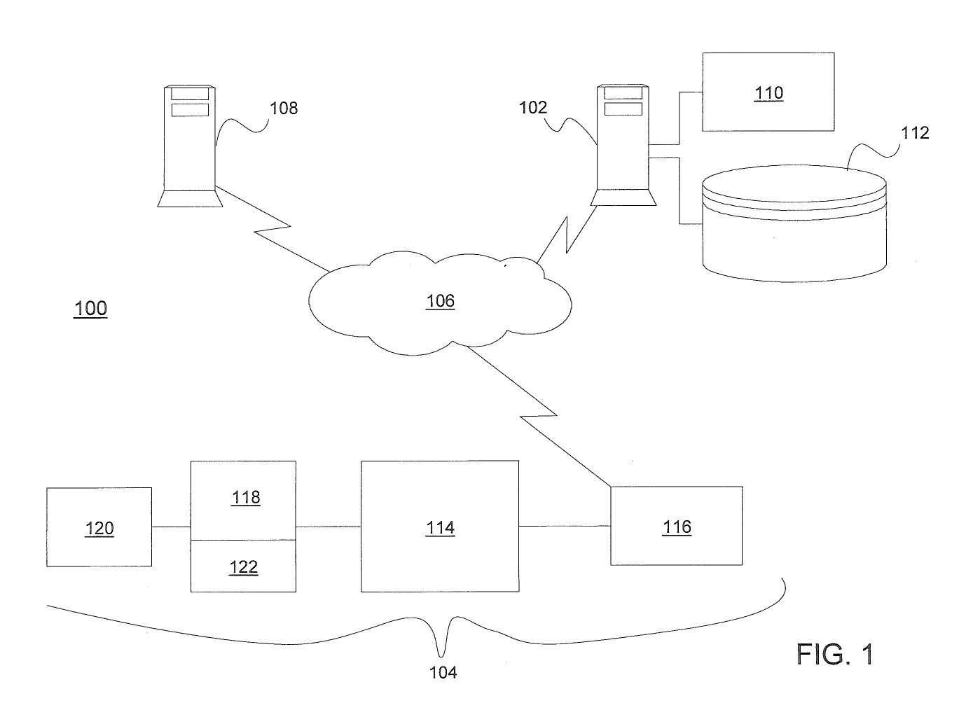

Turning now to FIG. 1, a system 100 upon which electric vehicle charging services may be implemented will now be described in an exemplary embodiment. The system 100 includes a host system 102 and components of a vehicle 104 in communication with one another over one or more networks 106. Also included in the system 100 is a utility service provider system 108.

The host system 102 may be implemented as a high-speed computer processing device (e.g., a mainframe computer) capable of handling a high volume of activities conducted between the host system 102 and network entities, such as the vehicle 104 and the utility service provider system 108. The host system 102 may be operated by an enterprise or organization implementing the exemplary electric vehicle charging services described herein. In one embodiment, the host system 102 may be a telematics service provider that provides emergency services including roadside assistance to vehicle owners or operators. The host system 102 may operate as a web server including a web site for generating subscription accounts and registered user records for the electric vehicle charging services. The host system 102 may also operate as an application server including one or more applications for providing the electric vehicle charging services described herein. These one or more applications are collectively referred to herein as charge service logic 110. In an exemplary embodiment, the host system 102 provides a centralized facility, e.g., via a web site and user interface, for enabling electric vehicle owners to register for the electric vehicle services, and the centralized facility also enables utility service providers to engage in utility services for customers that provide discounted electric rates, as described herein.

The utility service provider system 108 may be implemented as a high-speed computer processing device (e.g., a mainframe computer) capable of handling a high volume of activities conducted between the utility service provider system 108 and its customers, such as the owner/operator of the vehicle 104. The utility service provider system 108 comprises an entity that provides electricity to customers residing in a region serviced by the utility service provider system 108. In an embodiment, the utility service provider system 108 may agree to provide discounted rates to customers (e.g., for off-peak usage of electricity and for electric vehicle charging). In this embodiment, the utility service provider system 108 enters an agreement with the host system 102 to offer discounted rates to registered users of the electric vehicle charging services.

The host system 102 is communicatively coupled to a storage device 112, which stores registered user records for the electric vehicle owners and operators of the electric vehicle charging services, as well as account records established for utility service providers that agree to provide discounted electric rates for the users. User records and account records created via the charge service logic 110 may include personal information for registered users, such as user identification data (e.g., name, address, vehicle information, etc.) and statistical data concerning electrical energy consumed and cost savings accrued by users. While the storage device 112 is shown in FIG. 1 as a separate physical device from the host system 102, it will be understood that the storage device 112 may be integrated into the host system 102 as internal storage (e.g., as a hard disk drive) or may be communicatively coupled to the host system 102 over a network, such as networks 106.

The networks 106 may be any type of known networks in the art. For example, the networks 106 may be a combination of public (e.g., Internet), private (e.g., local area network, wide area network, virtual private network), and may include wireless and wireline transmission systems (e.g., satellite, cellular network, terrestrial networks, etc.).

The vehicle 104 is an electric or hybrid vehicle that includes a body control module 114 that is communicatively coupled, e.g., via physical wiring or a secure wireless local area network, to a telematics system 116 and a vehicle battery 118. The body control module 114 includes one or more computer processors and logic for directing communications among various vehicle components, such as the battery 118 and the telematics system 116. The telematics system 116 provides two-way communications between the vehicle 104 and network entities, such as the host system 102 over the network 106. The telematics system 116 includes a computer processor, logic, and transceiver for implementing various telematics features, such as communications to a telematics service provider when an emergency arises or when roadside assistance is needed. The telematics system 116 also includes a global positioning system component for use in determining the vehicle's 104 location.

The battery 118 may be a high-voltage battery that powers the vehicle 104 and is charged via a battery charger 120 when coupled to the battery 118. In an exemplary embodiment, the battery 118 includes a computer processor 122 that communicates the amount of electric energy consumed by the battery 118 during a charge operation to the telematics system 116 via the body control module 114. In turn, the telematics system 116 communicates this data over the networks 106 to the host system 102, as will be described further herein. The computer processor 122 includes hardware elements (e.g., circuitry, logic cores, registers, etc.) for processing data configured to implement the exemplary electric vehicle charging services described herein.

In one embodiment, the vehicle 104 may include infotainment system components (not shown), such as a deck, tuner, audio system devices including speakers and amplifiers, as well as display devices for presenting audio and other information to the user.

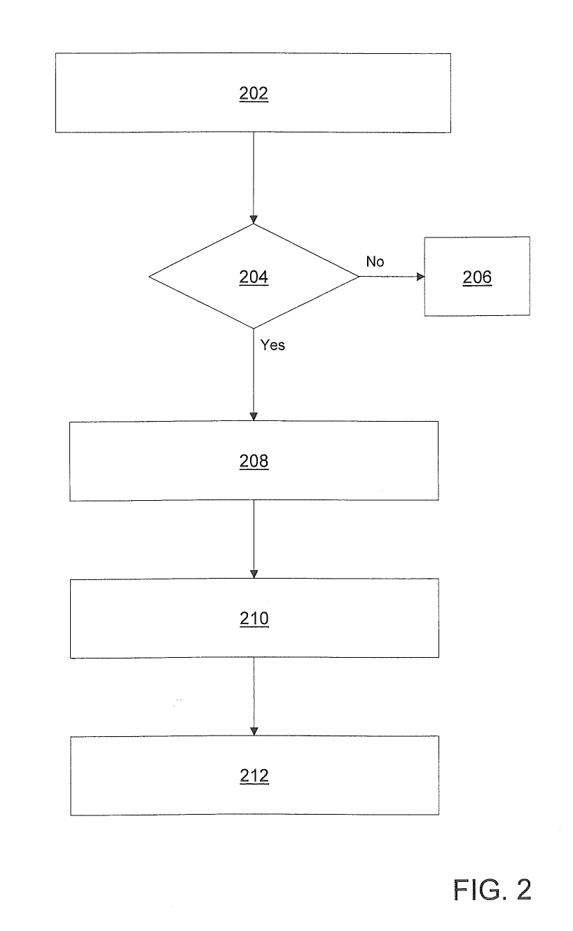

As indicated above, the electric vehicle charging services enable a utility service provider to offer discounted rates to owners and operators of electric and hybrid vehicles without any additional required hardware, devices, or instrumentation. Turning now to FIG. 2, a process for implementing the electric vehicle charging services will now be described in an exemplary embodiment. The processes described in FIG. 2 assume that a user has activated a vehicle charging unit (e.g., the battery charger 120) to initiate a charging operation for the vehicle 104. The battery 118 transmits data indicating the amount of energy consumed (e.g., in units) to the body control module 114, which in turn, transmits the data to the telematics system 116, and the telematics system 116 sends the data, as well as identification information over the networks 106 to the host system 102. The identification information may include the vehicle identification number or other uniquely identifying information. Alternatively, the identification information may be ascertained from the vehicle location information described below.

At step 202, the host system 102 receives the identification information and vehicle charging data (e.g., the amount of energy consumed during a charge operation). In addition, the charge service logic 110 records or logs the time at which the charge operation occurs. This may be determined from the time the information is received at the host system 102, as the charge operation and transmission of data to the host system 102 may occur in near real time. At step 204, the charge service logic 110 accesses user records in the storage device 112 to determine if the user is registered for the electric vehicle charging services. If the user has not registered for the electric vehicle charging services at step 204, the charge service logic 110 may be configured to transmit an offer to register for the electric vehicle charging services over the networks 106 at step 206. The offer may be communicated to the telematics system 116, which transmits the offer to the body control module 114 for display on a display device of the vehicle 104. The user may register for the electric vehicle charging services either directly via the telematics system 116 or may use other convention means, such as over the telephone or via a web site of the host system 102.

At step 208, if the user is determined to be a registered user of the electric vehicle charging services, the charge service logic 110 directs the telematics system 116 to determine and provide current location information for the vehicle 104. The telematics system 116 global positioning system component determines the location and provides this information to the charge service logic 110 over the networks 106.

At step 210, the charge service logic 110 uses this location information to determine a utility service provider (e.g., utility service provider system 108) that services the location of the vehicle 104. In one embodiment, the host system 102 stores utility service provider information for each utility service provider located in regions serviced by the host system 102 and the electric vehicle charging services. This information may be stored in the storage device 112.

Once the utility service provider has been identified, the charge service logic 110 is configured to transmit the charge data (e.g., amount of electric energy consumed in the charge operation) and the corresponding time of the charge operation to the corresponding utility service provider at step 212. In addition, the charge service logic 110 transmits the user identification information associated with the charge data over the networks 106 to the utility service provider. This user identification information may be transmitted using secure transmission technologies, such as encryption to ensure the integrity of the data. Any costs savings accrued by the user using the electric vehicle charging services may be calculated by the charge service logic 110 and presented to the vehicle 104 for display on a display device onboard the vehicle 104.

The utility service provider provides the discounted rate to the user based on the time the charge operation occurred, and bills the user using the information received from the host system 102.

As indicated above, in alternative embodiments, the charge service logic 110 may be configured to identify a user via the location of the vehicle 104. For example, if the vehicle 104 is always charged at the user's home address, the home address information may be determined by the charge service logic 110 using global positioning system coordinates captured by the telematics system 116. In this embodiment, the user is identified as a registered user after the location of the vehicle 104 is identified.

Technical effects include electric vehicle charging services that provide owners and operators of electric or hybrid vehicles with discounted electric rates for electrical energy consumed by their vehicles from utility service providers who agree to participate in these services. Once a vehicle owner or operator registers for the electric vehicle charging services and initiates a charge operation, the vehicle components capture the amount of energy consumed in the charge operation and transmit this information, along with user identification and current location information to the electric vehicle charging services provider via a telematics system, and the electric vehicle charging services provider, in turn, provides this information to the corresponding utility service provider. The utility service provider provides the discounted rate and bills the user using the information received from the electric vehicle charging services provider. By transmitting the user identification information, location information, and charge data via a telematics system and network, no additional hardware or devices are needed, such as a smart meter or other specialized instrumentation.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A system for implementing electric vehicle charging services, the system comprising:
a host system computer; and
logic executable by the host system computer, the logic configured to implement a method, the method comprising:
receiving data relating to a vehicle charge operation of a vehicle and a user identification of the user initiating the vehicle charge operation; and
upon determining the user has registered for the electric vehicle charging services:
identifying a location of the vehicle;
determining a utility service provider that services the location, the utility service provider offering discounted electricity rates to operators of electric vehicles; and
transmitting charge data, time of the vehicle charge operation, and the user identification received from the vehicle to the utility service provider, the charge data and the time of the vehicle charge operation determining a rate chargeable to the user.

2. The system of claim 1, wherein the logic is further configured to implement:
upon determining the user is not registered for the electric vehicle charging services, presenting an offer to the user to register for the electric vehicle charging services on a display device in the vehicle.

3. The system of claim 1, wherein the logic is further configured to implement:
calculating a value reflecting an amount of energy consumed at a discounted rate with respect to the vehicle charge operation, and displaying data specifying cost savings accrued on a display device in the vehicle.

4. The system of claim 1, wherein the user identification comprises a home address of the user, and the location of the vehicle is determined by global positioning system coordinates associated with the home address.

5. The system of claim 1, wherein the user identification is a vehicle identification number.

6. The system of claim 1, wherein the logic is further configured to implement:
encrypting the user identification before transmitting the user identification to the utility service provider.

7. The system of claim 1, wherein the logic is further configured to implement:
receiving the charge data from a body control module and telematics system in the vehicle via a network.

8. A method for implementing electric vehicle charging services, the method comprising:
receiving data relating to a vehicle charge operation of a vehicle and a user identification of the user initiating the vehicle charge operation; and
upon determining the user has registered for the electric vehicle charging services:
identifying a location of the vehicle;
determining a utility service provider that services the location, the utility service provider offering discounted electricity rates to operators of electric vehicles; and
transmitting charge data, time of the vehicle charge operation, and the user identification received from the vehicle to the utility service provider, the charge data and the time of the vehicle charge operation determining a rate chargeable to the user.

9. The method of claim 8, further comprising:
upon determining the user is not registered for the electric vehicle charging services, presenting an offer to the user to register for the electric vehicle charging services on a display device in the vehicle.

10. The system of claim 1, further comprising:
calculating a value reflecting an amount of energy consumed at a discounted rate with respect to the vehicle charge operation, and displaying data specifying cost savings accrued on a display device in the vehicle.

11. The method of claim 1, wherein the user identification comprises a home address of the user, and the location of the vehicle is determined by global positioning system coordinates associated with the home address.

12. The method of claim 1, wherein the user identification is a vehicle identification number.

13. The method of claim 1, further comprising:
encrypting the user identification before transmitting the user identification to the utility service provider.

14. The method of claim 1, further comprising:
receiving the charge data from a body control module and telematics system in the vehicle via a network.

15. A computer program product implementing electric vehicle charging services, the computer program product comprising a computer-readable storage medium encoded with instructions, which when executed by a computer cause the computer to implement a method, the method comprising:
receiving data relating to a vehicle charge operation of a vehicle and a user identification of the user initiating the vehicle charge operation; and
upon determining the user has registered for the electric vehicle charging services:
identifying a location of the vehicle;
determining a utility service provider that services the location, the utility service provider offering discounted electricity rates to operators of electric vehicles; and
transmitting charge data, time of the vehicle charge operation, and the user identification received from the vehicle to the utility service provider, the charge data and the time of the vehicle charge operation determining a rate chargeable to the user.

16. The computer program product of claim 15, wherein the instructions further implement:
upon determining the user is not registered for the electric vehicle charging services, presenting an offer to the user to register for the electric vehicle charging services on a display device in the vehicle.

17. The computer program product of claim 15, wherein the instructions further implement:
calculating a value reflecting an amount of energy consumed at a discounted rate with respect to the vehicle charge operation, and displaying data specifying cost savings accrued on a display device in the vehicle.

18. The computer program product of claim 15, wherein the user identification comprises at least one of:
a home address of the user, and the location of the vehicle is determined by global positioning system coordinates associated with the home address; and
a vehicle identification number.

19. The computer program product of claim 15, wherein the instructions further implement:
encrypting the user identification before transmitting the user identification to the utility service provider.

20. The computer program product of claim 15, wherein the instructions further implement:
receiving the charge data from a body control module and telematics system in the vehicle via a network.
